(19) United States
(12) Patent Application Publication
(10) Pub. No.: US 2018/0251953 A1
(43) Pub. Date: Sep. 6, 2018

(54) BALL SOCKET ASSEMBLY FOR A WORK VEHICLE

(71) Applicant: Deere & Company, Moline, IL (US)

(72) Inventor: Michael R. Dorman, Dubuque, IA (US)

(21) Appl. No.: 15/449,845

(22) Filed: Mar. 3, 2017

(51) Int. Cl. E02F 9/00; E02F 3/76; E02F 3/815

(52) U.S. Cl. CPC E02F 9/006; E02F 3/7622; F16C 11/068; E02F 3/7627; E02F 3/7631; E02F 3/8157

(57) ABSTRACT

A work vehicle with a chassis, a ground-engaging blade movably coupled to the chassis via a ball and socket assembly to allow the blade to pivot relative to the chassis. The ball and socket assembly comprises a semi-spherical socket with at least a first circular groove on a surface of the socket positioned coaxially with a centerline axis of the semi-spherical socket, a second circular groove concentric and spaced apart from the first circular groove along the surface of the socket, and at least two interconnecting grooves coupling the circular groove and the second circular groove; and a ball member disposed within the socket.

### CROSS-REFERENCE TO RELATED APPLICATIONS

N/A

### FIELD OF THE DISCLOSURE

The present disclosure relates to a ball socket assembly for a work vehicle where the ball socket assembly couples a ground-engaging blade with a chassis.

### BACKGROUND

Work vehicles with ground-engaging blades may be used to shape and smooth ground surfaces. Such work vehicles may be supported by wheels or tracks which may encounter raised and lowered features on the ground as the work vehicles move, which cause stress on the ball socket assembly coupling the ground-engaging blade with the chassis of the work vehicle. The stress is amplified if the ball socket assembly is insufficiently lubricated, thereby increasing the rate of wear of the ball socket assembly.

### SUMMARY

This summary is provided to introduce a selection of concepts that are further described below in the detailed description and accompanying drawings. This summary is not intended to identify key or essential features of the appended claims, nor is it intended to be used as an aid in determining the scope of the appended claims.

The present disclosure includes a ball and socket assembly for a work vehicle, wherein the work vehicle comprises a chassis, a ground-engaging blade movably coupled to the chassis via the ball and socket assembly to allow the blade to pivot relative to the chassis.

According to an aspect of the present disclosure, the ball and socket assembly comprises a semi-spherical socket with at least a first circular groove on a surface of the socket positioned coaxially with a centerline axis of the semi-spherical socket, a second circular groove concentric and spaced apart from the first circular groove along the surface of the socket, and at least two interconnecting grooves coupling the first circular groove and the second circular groove; and a ball member disposed within the socket.

The ball and socket assembly may further comprise a closure plate to retain the ball member within the socket.

The ball and socket assembly may further comprise a first grease fitting coupled with the first circular groove and the second grease fitting coupled with the second circular groove.

The first grease fitting and the second grease fitting may further be positioned at least ninety degrees from a perspective of a plane perpendicular to the centerline axis.

The first grease fitting and the second grease fitting may also be equidistant from a vertical plane along the length of the centerline axis.

In another embodiment, the socket may comprise at least eight interconnecting grooves coupling the first circular groove and the second circular groove.

The interconnecting grooves may extend radially along a path originating from the centerline axis.

The interconnecting grooves may further be equally spaced from one another.

Furthermore, the intersection of the surface of the socket and a groove may be one of a chamfer, a bevel, or a fillet.

These and other features will become apparent from the following detailed description and accompanying drawings, wherein various features are shown and described by way of illustration. The present disclosure is capable of other and different configurations and its several details are capable of modification in various other respects, all without departing from the scope of the present disclosure. Accordingly, the detailed description and accompanying drawings are to be regarded as illustrative in nature and not as restrictive or limiting.

### BRIEF DESCRIPTION OF THE DRAWINGS

The detailed description of the drawings refers to the accompanying figures in which:

FIG. 1 is a perspective view of a work vehicle, for example a crawler dozer.

FIG. 2 is an exploded perspective view of a ball socket assembly and a portion of a crawler dozer.

FIG. 3 is a cross-sectional side view of the semi-spherical socket and cylinder member in the cylinder member.

FIG. 4 is a view of the semi-spherical socket and cylinder member from a perspective a plane perpendicular to the central axis.

FIG. 5 is a cross-sectional view of an intersection between the surface of the socket and a groove.

FIG. 5a is a detailed cross-sectional view of an intersection between the surface of the socket and a groove shown as a chamfer.

FIG. 5b is a detailed cross-sectional view of an intersection between the surface of the socket and a groove shown as a bevel.

FIG. 5c is a detailed cross-sectional view of an intersection between the surface of the socket and a groove shown as a fillet.

### DETAILED DESCRIPTION

The embodiments disclosed in the above drawings and the following detailed description are not intended to be exhaustive or to limit the disclosure to these embodiments. Rather, there are several variations and modifications which may be made without departing from the scope of the present disclosure.

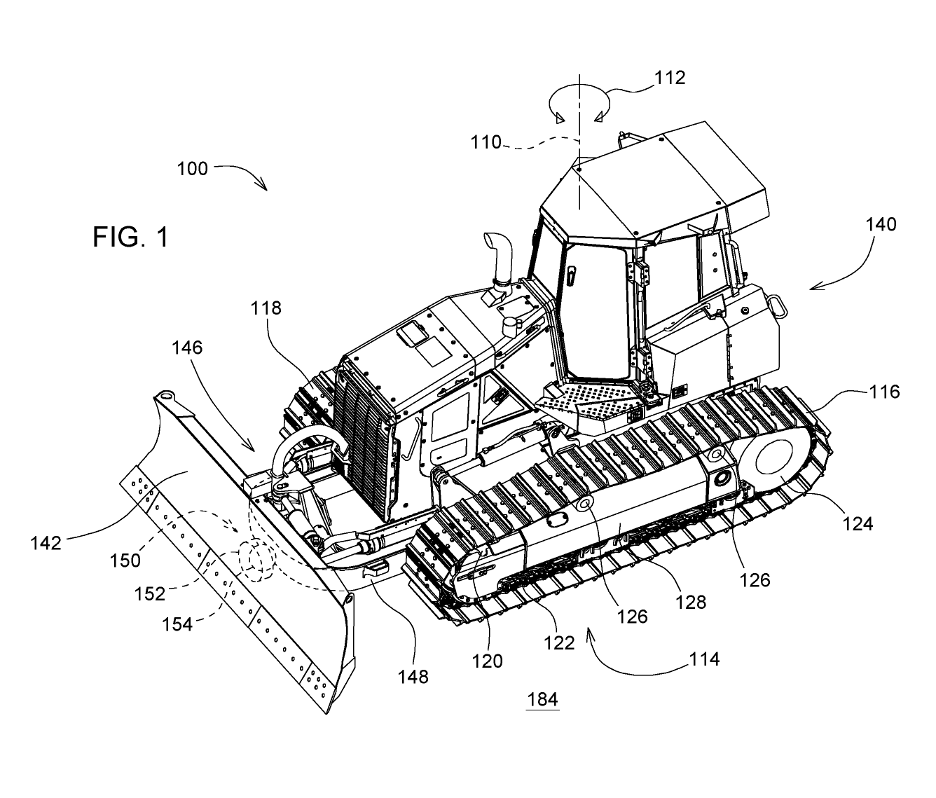

FIG. 1 is a perspective view of work vehicle 100. Work vehicle 100 is illustrated as a crawler dozer, which may be referred to as a crawler, but may be any work vehicle with a ground-engaging blade or work implement such as a compact track loader, motor grader, scraper, skid steer, and tractor, to name a few examples. Work vehicle 100 may be operated to engage the ground and cut and move material to achieve simple or complex features on the ground.

Work vehicle is supported on the ground by undercarriage 114. Undercarriage 114 includes a left track 116 and a right track 118, which engage the ground and provide tractive force for the work vehicle 100. Left track 116 and right track 118 may be comprised of shoes with grousers that sink into the ground to increase traction, and interconnecting components may include links, pins, bushings, and guides, to name a few components. Front idlers 120, track rollers 122, and rear sprockets 124, and top idlers 126 are all pivotably connected to the remainder of work vehicle 100 and rotationally coupled to their respective tracks so as to rotate with those tracks. Track frame 128 provides structural support to these components and the remainder of undercarriage 114.

Undercarriage 114 is affixed to, and provides support and tractive effort for, chassis 140 of work vehicle 100. Chassis 140 is the frame which provides structural support and rigidity to work vehicle 100, allowing for the transfer of forces between blade 142 and left track 116 and right track 118. In this embodiment, chassis 140 is a weldment comprised of multiple formed and joined and steel members, but in alternative embodiments it may be comprised of any number of different materials or configurations.

Blade 142 is a work implement which may engage the ground or material to move or shape it. Blade 142 may be used to move material from one location to another and to create features on the ground, including flat areas, grades, hills, roads, or more complexly shaped features. In this embodiment, blade 142 of work vehicle 100 may be referred to as a six-way blade, six-way adjustable blade, or power-angle-tilt (PAT) blade. Blade 142 may be hydraulically actuated to move vertically up or vertically down (which may also be referred to as blade lift, or raise and lower), roll left or roll right (which may be referred to as blade tilt, or tilt left and tilt right), and yaw left or yaw right (which may be referred to as blade angle, or angle left and angle right). Alternative embodiments may utilize a blade with fewer hydraulically controlled degrees of freedom, such as a 4-way blade that may not be angled, or actuated in the direction of yaw 112.

Blade 142 is movably connected to chassis 140 of work vehicle 100 through linkage 146, which supports and actuates blade 142 and is configured to allow blade 142 to be raised or lowered relative to chassis 140 (i.e., moved in the direction of vertical 110). Linkage 146 may include multiple structural members to carry forces between blade 142 and the remainder of work vehicle 100 and may provide attachment points for hydraulic cylinders which may actuate blade 142 in the lift, tilt, and angle directions.

Linkage 146 includes c-frame 148, a structural member with a C-shape positioned rearward of blade 142, with the C-shape opening toward the rear of work vehicle 100. Each rearward end of c-frame 148 is pivotally connected to chassis 140 of work vehicle 100, such as through a pin-bushing joint, allowing the front of c-frame 148 to be raised or lowered relative to work vehicle 100 about the pivotal connections at the rear of c-frame 148. The front portion of c-frame 148, which is approximately positioned at the lateral center of work vehicle 100, connects to blade 142 through a ball-socket assembly 150. This allows blade 142 three degrees of freedom in its orientation relative to c-frame 148 (lift-tilt-angle) while still transferring rearward forces on blade 142 to the remainder of work vehicle 100.

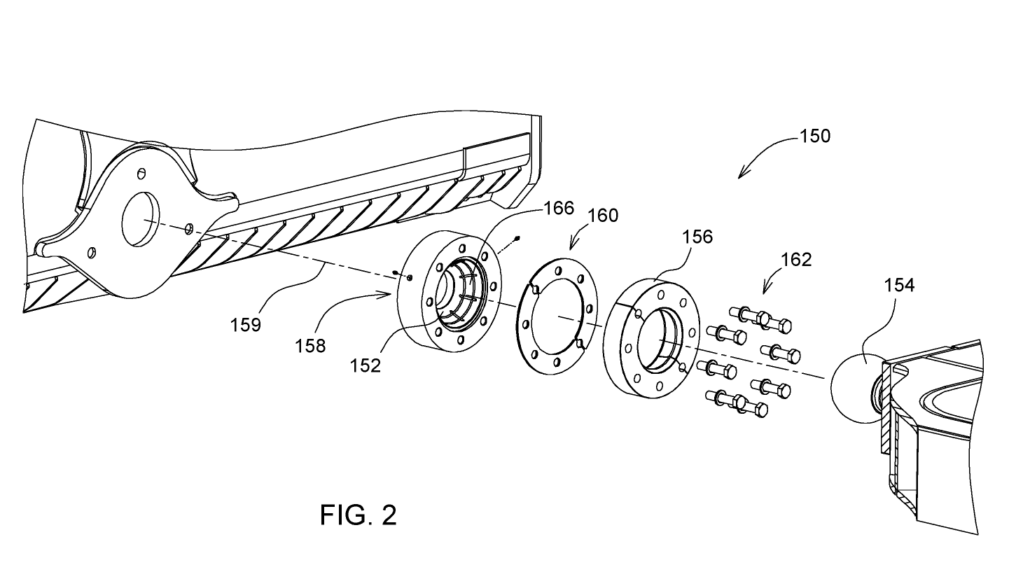

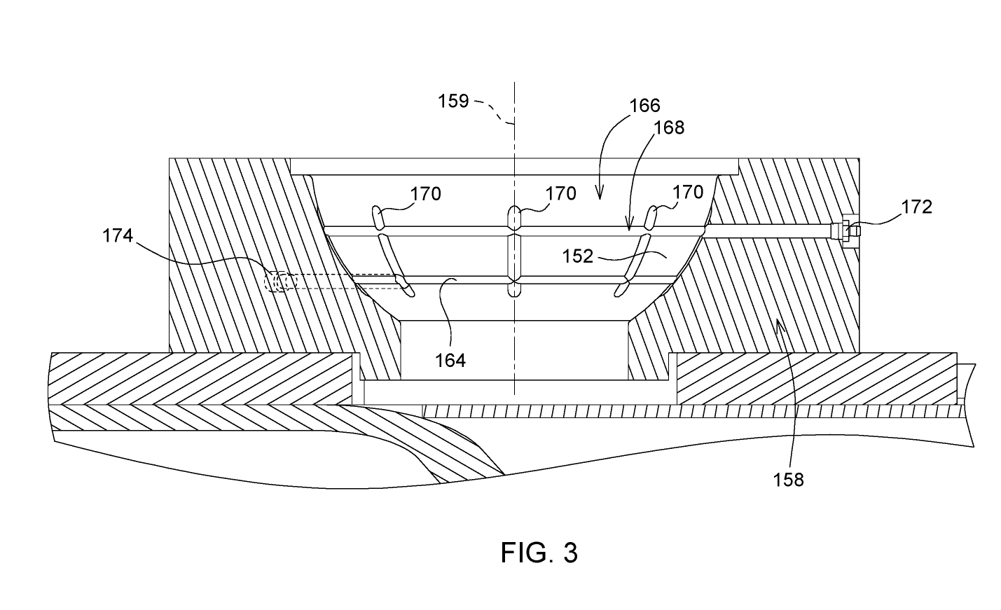

Now referring to FIG. 2, an exploded view of the ball and socket assembly 150, the assembly 150 comprises a semi-spherical socket 152 and a ball member 154 disposed within the socket 152. The ball and socket assembly 150 further comprises a closure plate 156 to retain the ball member 154 within the socket 152. According to the embodiment shown in FIG. 2, the socket is a semi-spherical recess container within a cylindrical member 158. The semi-spherical aspect of the socket 152 may either be a full semi-sphere (not shown) or only a portion of a semi-sphere (as shown in FIG. 3) wherein the semi-sphere revolves around a centerline axis 159 of the socket 152. The closure plate 156 contains a through-hole sufficiently large to retain the ball member 154 within the socket. A gasket 160 may also be positioned between the socket 152 and a closure plate 156 to prevent any leakage of lubrication placed in the socket 152. The ball member 154 is generally spherical in shape, fitting snuggly within the socket 152 with sufficient clearance to move vertically up or down, roll left or roll right, or yaw left or yaw right. The closure plate 156 is secured to the cylindrical member 158 via a plurality of fasteners 162.

Referring again to FIG. 1, this particular embodiment identifies the socket 152 as coupled to the ground-engaging blade 142 and the ball member 154 as coupled to the chassis 140. However, in an alternative embodiment, the ball member 154 may be coupled to the ground-engaging blade 142 and the socket 152 may be coupled to the chassis 140.

Now referring to FIG. 3, a cross-sectional view of a portion of the cylinder member 158 showing an embodiment of the semi-spherical socket 152, the socket 152 comprises at least a first circular groove 164 on a surface 166 of the socket 152 positioned coaxially with the centerline axis 159 of the socket 152, a second circular groove 168 concentric and spaced apart from the first circular groove 164 along the surface 166 of the socket, and at least two interconnecting grooves 170 coupling the first circular groove 164 and the second circular groove 168. The grooves 164, 168, 170 function as a reservoir for lubricant, thereby permitting the joint to be used without frequently re-injecting lubricant therein. Please note, that although only two circular grooves 164, 168 are disclosed in this embodiment, multiple circular grooves may be added depending on the surface area of the socket 152 to be lubricated.

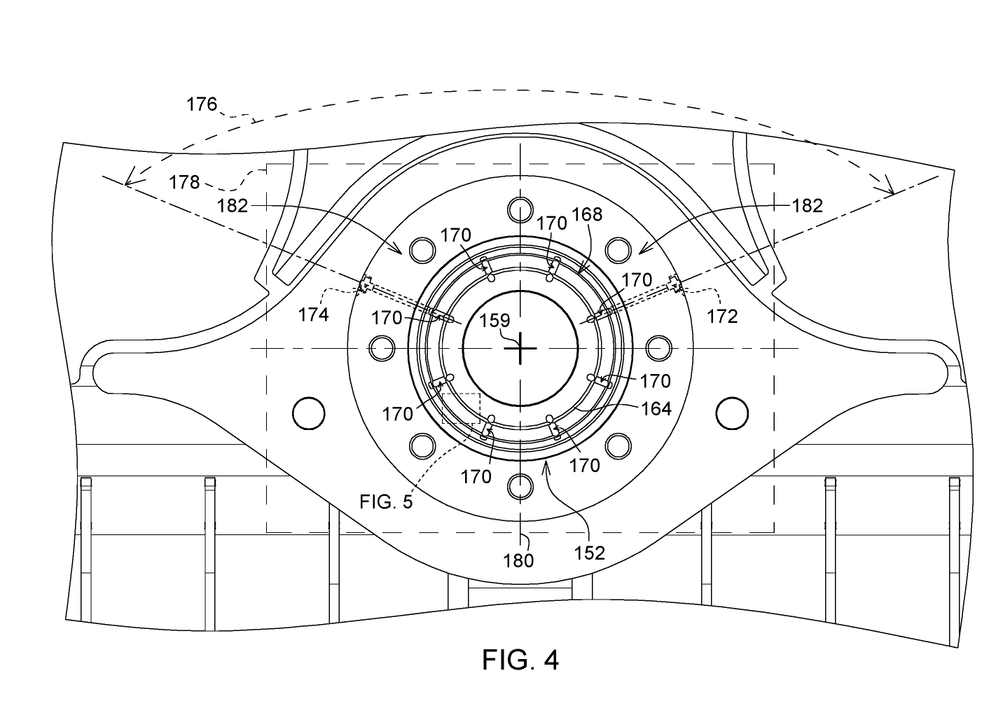

In one embodiment, as shown in FIG. 4, the socket may comprise eight interconnecting grooves 170 coupling the first circular groove 164 and the second circular groove 168. The interconnecting grooves 170 extend radially along a path originating from the centerline axis 159. The interconnecting grooves 170 may also be equally spaced from one another. More specifically, the interconnecting grooves 170 may be equally spaced from one another about the centerline axis 159.

The socket further comprises at least two grease fittings 172, 174. The first grease fitting 172 is coupled with the first circular groove 164 and the second grease fitting 174 is coupled with the second circular groove 168. The coupling of a grease fitting 172, 174 to each respective circular groove 164, 168 ensures the grease is more evenly distributed along a greater surface area of the ball member 154 (as shown in FIG. 2) and the socket 152. This may done, for example, through direct connection or through an additional groove through the cylinder member coupling the grease fitting 172, 174 to the circular groove 164, 168. The additional groove may be sized sufficiently large to minimize clogging of the additional grooves with debris as the work vehicle 100 typically operates in dirty environments. Grease fittings 172, 174 are metal fittings used in mechanical systems to feed lubricants, usually lubricating grease, into a ball and socket assembly under moderate to high pressure using a grease gun. The grease fitting 172, 174 may be permanently installed in the socket by a threaded connection, with a nipple connection for attachment of a grease gun. In one type of grease fitting (172, 174), the pressure supplied by the grease gun forces a small captive ball bearing in the fitting to move back against the force of a retaining spring within the fitting valves, thereby opening the valve under sufficient pressure to allow lubricant to pass through to the circular grooves and the interconnecting grooves. When the pressure ceases, the ball returns to its closed position. The ball excludes dirt and functions as a check valve to prevent grease from escaping back out of the fitting. Please note that although this embodiment discloses two grease fittings, additional grease fittings may be coupled to the grooves 164, 168, 170 in the socket 152.

As shown in FIG. 4, the first grease fitting 172 is positioned at least ninety degrees 176 from the second grease 174 fitting from a perspective of a plane 178 perpendicular to the centerline axis 159. The first grease fitting 172 and the second grease fitting 174 may further be equidistant from a vertical plane 180 along the length of the length centerline axis 159. More particularly, the grease fittings 172,174 are located in the upper hemisphere 182 of the socket 152. The upper hemisphere 182 is defined as the top half of the semi-spherical socket 152, wherein the top half is the half positioned away from the ground 184 (shown in FIG. 1). These grease fittings 172,174 provide ease of accessibility for an operator when lubricating the ball and socket assembly 150 (as shown in FIG. 2). Referring again to FIG. 1, according to one embodiment, the socket 152 may be approximately two and a half feet in diameter centered on a blade 142 that may be 15 feet wide, with linkage 146 and hydraulic components 186 connecting the blade 142 to chassis 140. Positioning of the grease fittings 172, 174 as described allows an operator to easily overstep any linkage 146 or hydraulic components 186, lubricating the ball and socket assembly 150 as needed.

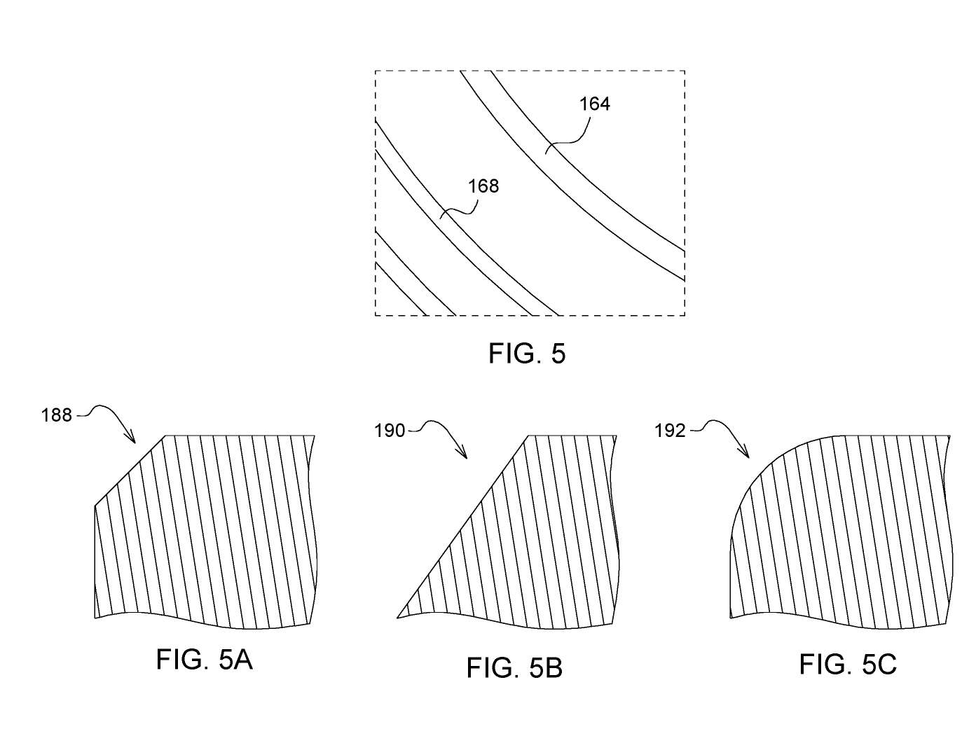

In order to further facilitate smooth pivoting between the ball member 154 and the socket 152, the surface 166 of the socket 152 may be treated with a process (e.g. buffing, sanding, polishing) to smooth out any sharp edges created from manufacturing the circular grooves 164, 168 and the interconnecting grooves 170. As shown in FIG. 5, an intersection of the surface 166 of the socket 152 and the groove 164, 168, 179 may be one of a chamfer 188 (FIG. 5a), a bevel 190 (FIG. 5b), or a fillet 192 (FIG. 5c).

One or more of the steps or operations in any of the methods, processes, or systems discussed herein may be omitted, repeated, or re-ordered and are within the scope of the present disclosure.

While the above describes example embodiments of the present disclosure, these descriptions should not be viewed in a restrictive or limiting sense. Rather, there are several variations and modifications which may be made without departing from the scope of the appended claims.

What is claimed is:

1. A work vehicle comprising:
a chassis,
a ground-engaging blade movably coupled to the chassis via a ball and socket assembly to allow the blade to pivot relative to the chassis,
wherein the ball and socket assembly comprises a semi-spherical socket with at least a first circular groove on a surface of the socket positioned coaxially with a centerline axis of the semi-spherical socket, a second circular groove concentric and spaced apart from the first circular groove along the surface of the socket, and at least two interconnecting grooves coupling the first circular groove and the second circular groove; and
a ball member disposed within the socket.

2. The work vehicle of claim 1, wherein the socket further comprises:
a first grease fitting coupled with the first circular groove, and
a second grease fitting coupled with the second circular groove.

3. The work vehicle of claim 2, wherein the first grease fitting and the second grease fitting are positioned at least ninety degrees from the second grease fitting from a perspective of a plane perpendicular to the centerline axis.

4. The work vehicle of claim 2, wherein the first grease fitting and the second grease fitting are equidistant from a vertical plane along the length of the centerline axis.

5. The work vehicle of claim 1, wherein the socket further comprises at least eight interconnecting grooves coupling the first circular groove and the second circular groove.

6. The work vehicle of claim 1, wherein the interconnecting grooves extend radially along a path originating from the centerline axis.

7. The work vehicle of claim 6, wherein the interconnecting grooves are equally spaced from one another.

8. The work vehicle of claim 1, wherein an intersection of the surface of the socket and the groove is one of a chamfer, bevel, or a fillet.

9. The work vehicle of claim 1, wherein the ball and socket assembly further comprises a closure plate to retain the ball member within the socket.

10. The work vehicle of claim 1, wherein the socket is coupled to the ground-engaging blade and the ball is coupled to the chassis.

11. A ball and socket assembly for a work vehicle, wherein the work vehicle comprises a chassis, a ground-engaging blade movably coupled to the chassis via the ball and socket assembly to allow the blade to pivot relative to the chassis wherein the ball and socket assembly comprises:
a semi-spherical socket with at least a first circular groove on a surface of the socket positioned coaxially with a centerline axis of the semi-spherical socket, a second circular groove concentric and spaced apart from the first circular groove along the surface of the socket, and at least two interconnecting grooves coupling the first circular groove and the second circular groove; and
a ball member disposed within the socket.

12. The ball and socket assembly of claim 11, wherein the socket further comprises:
a first grease fitting coupled with the first circular groove, and
a second grease fitting coupled with the second circular groove.

13. The ball and socket assembly of claim 12, wherein the first grease fitting and the second grease fitting are positioned at least ninety degrees from the second grease fitting from a perspective of a plane perpendicular to the centerline axis.

14. The ball and socket assembly of claim 12, wherein the first grease fitting and the second grease fitting are equidistant from a vertical plane along the length of the centerline axis.

15. The ball and socket assembly of claim 11, wherein the socket further comprises at least 8 interconnecting grooves coupling the first circular groove and the second circular groove.

16. The ball and socket assembly of claim 11, wherein the interconnecting grooves extend radially along a path originating from the centerline axis.

17. The ball and socket assembly of claim 16, wherein the interconnecting grooves are equally spaced from one another.

18. The ball and socket assembly of claim 11, wherein an intersection of the surface of the socket and a groove is one of a chamfer, bevel, or a fillet.

19. The ball and socket assembly of claim 11, wherein the ball and socket assembly further comprises a closure plate to retain the ball member within the socket.

20. The ball and socket assembly of claim 11, wherein the socket is coupled to the ground-engaging blade and the ball is coupled to the chassis.
